(19) United States
(12) Patent Application Publication
(10) Pub. No.: US 2005/0005177 A1
(43) Pub. Date: Jan. 6, 2005

(54) Computer system and adapter conserving battery power and method thereof

(75) Inventor: Joon-ho Han, Seoul City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/834,065

(22) Filed: Apr. 29, 2004

(30) Foreign Application Priority Data
Jul. 4, 2003 (KR) 2003-45442

(51) Int. Cl. G06F 1/26

(52) U.S. Cl. 713/300

(57) ABSTRACT

A computer system including an adapter, a computer main body, and a connector connecting the adapter and the computer main body. The adapter includes a source power connector supplying an input power, a power converter converting the input power into an output power, an output power connector outputting the output power to a computer main body, a plurality of ports to which an external device is connected, and a controller receiving the output power from the power converter and controlling a signal inputted/outputted to the port. Aspects of the present invention provide a computer system including an adapter having a hub communicating with an external device without a battery discharge, and a plurality of ports.

### CROSS-REFERENCE TO RELATED APPLICATIONS

This application claims the benefit of Korean Patent Application No. 2003-45442, filed Jul. 4, 2003, in the Korean Intellectual Property Office, the disclosure of which is incorporated herein by reference.

### BACKGROUND OF THE INVENTION

1. Field of the Invention

The present invention relates to a computer system, and more particularly, a computer system having an adapter operating as a hub.

2. Description of the Related Art

Conventional adapters include an AC (Alternating Current)/DC (Direct Current) adapter, a DC/DC adapter, and the like, the use of which depending on desired a power input/output format. The AC/DC adapter, converting AC power supplied to a home into DC power, is commonly used.

FIG. 1 illustrates a conventional AC/DC adapter. The AC/DC adapter 100 includes a plug 101 receiving AC power, a connector 102 outputting DC power, and an AC/DC converter (not shown) inside the adaptor.

A portable computer is operated by the power provided by such an AC/DC adapter 100 or by a charged battery (not shown). Recently, the portable computer also includes a separable docking station, and a port on a main body of the computer for a removable CD-ROM driver, FDD, and the like, for convenient portability.

A battery used by the portable computer is easily discharged when a serial communication port, such as an IEEE 1394 serial port with a 6-pin connector, is connected to the port for supplying power to external peripheral devices connected to the portable computer. Since in a conventional system an IEEE 1394 serial port with a 4-pin connector cannot supply power to external peripheral devices connected to the portable computer, a user is inconvenienced in the use of the external devices.

The conventional portable computer has a limited number i.e., one or two IEEE 1394 ports and each having 4-pins. Thus it is not easy to connect various external peripheral devices, such as a camcorder, a hard disk drive, and the like that use the IEEE 1394 standard, to the portable computer at the same time.

A hub serves as a center of a network, and an IEEE 1394 hub connects independently IEEE 1394 devices. As used herein, an IEEE 1394 device refers to a device operated by an IEEE 1394 controller as a stand-alone device without a host computer. Such IEEE 1394 devices including system and external independent devices are connected to the IEEE 1394 hub.

FIG. 2 is a block diagram of a configuration of a conventional external hub. As shown therein, the external hub 200 includes a controller 201, a port 202, and a power supplying part 203.

The controller 201 controls data communication and signal amplification. Various types of controllers are available depending on use. The port 202 is a terminal to which a connector of an external device is connected. The power supplying part 203 receives AC power from an external source and converts the received AC power into DC power, thereby supplying a predetermined power to the controller 201 and the port 202.

However, problems with the conventional external hub 200 include that an extra cable and an adapter are required to supply power.

### SUMMARY OF THE INVENTION

Accordingly, it is an aspect of the present invention to provide a computer system comprising an adapter having a hub that communicates with an external device without a battery discharge, and having a plurality of ports.

According to an aspect of the present invention a computer system is provided including an adapter, a computer main body, and a connector connecting the adapter and the computer main body. The adapter includes a source power connector supplying an input power, a power converter converting the input power into an output power, an output power connector outputting the output power to a computer main body, a plurality of ports to which an external device is connected, and a controller receiving the output power from the power converter and controlling a signal inputted/outputted to the port.

According to an aspect of the invention, the connector includes a power line supplying the output power to the computer main body from the output power connector, and a data line communicating between the controller and the computer main body.

According to an aspect of the invention, the power converter has a voltage dropper dropping voltage of the output power and supplying the dropped voltage to the controller.

According to an aspect of the invention, the computer system includes a switch switching the output power supplied to the controller.

According to an aspect of the invention, the switch switches the data line.

According to an aspect of the invention, the controller and the port support standard IEEE 1394 serial communication.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a perspective view of a conventional AC/DC adapter;

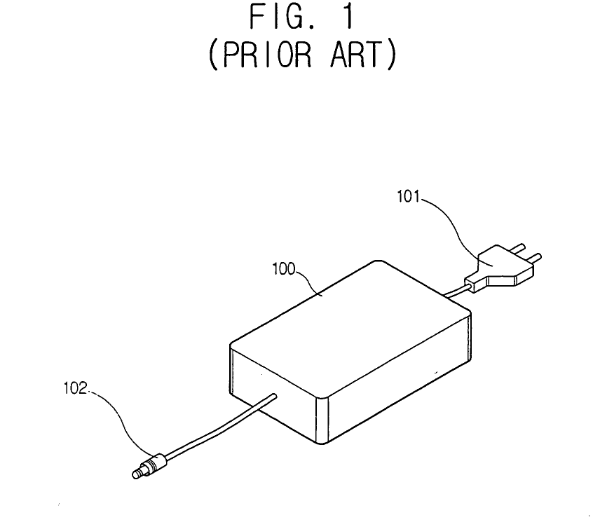

FIG. 2 is a block diagram of a conventional external hub;

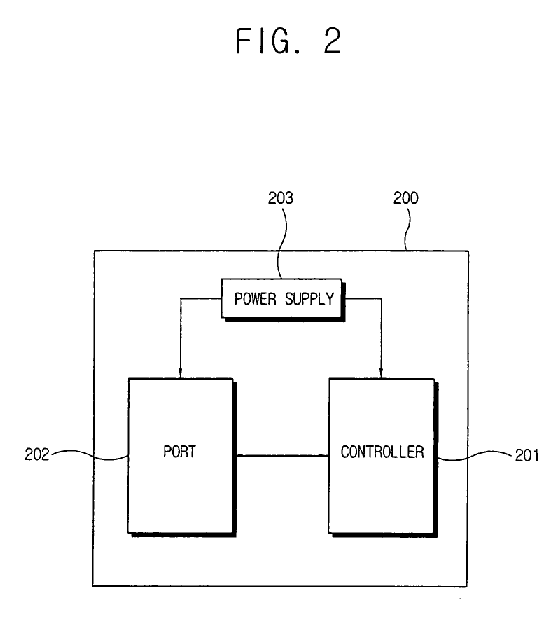

FIG. 3 is a block diagram of a computer system according to an embodiment of the present invention; and

FIG. 4 is a perspective view of an adapter according to the embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

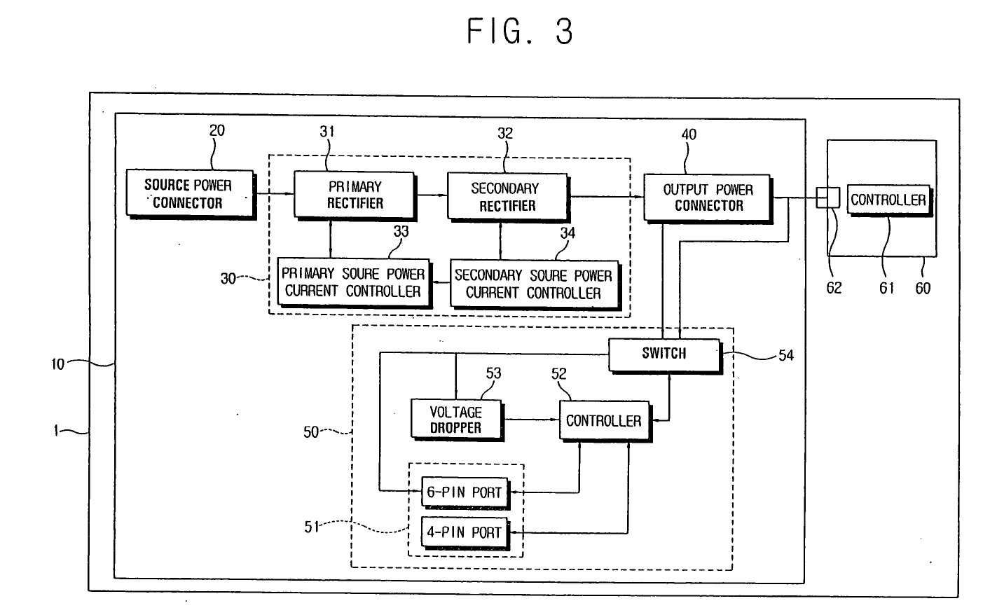

FIG. 3 is a configuration block diagram of a computer system according to an aspect of the present invention.

As shown therein, the computer system 1 includes an adapter 10, and a computer main body 60. The adapter 10 includes a source power connector 20, a power converter 30, an output power connector 40, and a hub 50.

The source power connector 20 receives AC power inputted to the adapter 10.

The power converter 30 converts the inputted AC power into a predetermined output DC power, and includes a primary rectifier 31, a secondary rectifier 32, a primary source power current controller 33, and a secondary source power current controller 34.

The AC input power inputted through the source power connector 20 flows into the primary rectifier 31. The limited size of the adapter 10 limits the size of a transformer. Therefore, a ripple is generated when DC power is output through the primary rectifier 31. Such DC power is input to the secondary rectifier 32, and rectified, rippleless DC power is output as an output power thereof. The primary source power current controller 33 checks voltage and current of the DC power rectified by the primary rectifier 31 and loaded to, and consumed by, the secondary rectifier 32, and controls the voltage and current of the DC power, thereby regulating the secondary rectifier 32. The secondary source power current controller 34 checks system loading and consumption of the output DC power and feeds back the checked result of the output to the primary source power current controller 33.

The output power connector 40 includes a connector supplying the DC power outputted from the secondary rectifier 32 of the power converter 30 to the system.

The hub 50 includes a port 51, a controller 52, a voltage dropper 53, and a switch 54.

The port 51 is a terminal connected to a connector of an external device. A 4-pin port and/or a 6-pin port is used if an IEEE 1394 standard serial communication method is applied. The 4-pin port has four lines transmitting data and controlling a signal, and the 6-pin port includes the four lines as in the 4-pin port and two additional lines respectively for grounding and power supply. The number of the ports 51 depends on the number of ports that the controller 52 supports.

The controller 52 receives the output DC power from the power converter 30 and controls a signal input to, and output from, the port 51. That is, the controller 52 controls a flow of the data and amplification of the signal. An aspect of the invention includes an IEEE 1394 controller 52 as the controller and configured to communicate.

The voltage dropper 53 decreases a predetermined DC output voltage supplied to the system. According to an aspect of the present invention, the voltage is decreased to as low as 3.3 volts. The decreased voltage is supplied to the controller 52 and the 6-pin port.

The switch 54 protects power consumption while the adapter 10 is not using the hub 50. The user chooses whether to cut off power supply to the hub 50. Also, the switch 54 switches data lines between the controller 52 of the hub 50 and the computer main body 60. Such switching is implemented by software or hardware.

The controller 52 and the port 51 allow IEEE 1394 serial communication. IEEE 1394 serial communication does not require a host computer, unlike USB (Universal Serial Bus) serial communication, thereby enabling direct data to be transmitted between the external devices. Thus, such an adapter 10 is used as a hub not only for portable computers, but also for other external devices.

The computer main body 60 includes an external connector 62 and a computer controller 61.

The external connector 62 is connected to a connector of the adapter 10 supplying input power. The external connector has an input/output port and communicates data with the controller 52 in the hub 50 of the adapter 10 through a data line of the connector. The 6-pin port of the hub 50 transmits a predetermined power directly supplied from the adapter 10 to the external devices without having a discharge of the battery in the portable computer. Therefore, according to an aspect of the present invention, the external connector 62 has a 4-pin input/output port. The controller 61 controls the data communication.

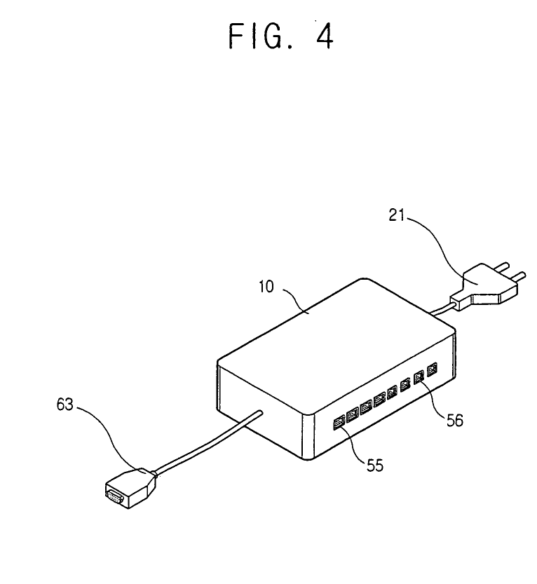

FIG. 4 is a perspective view of the adapter according to an aspect of the present invention. As shown therein, the adapter 10 includes a connector 63, a 6-pin port 55, a 4-pin port 56, and a plug 21.

The connector 63 is connectable with the computer main body 60 and supplies the power from the adapter 10 to the computer main body 60, and enables the controller 52 in the adapter 10 and the computer controller 61 in the computer main body 60 to communicate data with each other. The connector 63 includes a data line and a power line. The data line is implemented as an IEEE 1394 4-pin port since no extra power is supplied to the hub 50 from the computer main body 60.

A plug 21 receives power, and the 6-pin port 55 and the 4-pin port 56 are terminals respectively connectable to connectors of external devices.

According to an aspect of the present invention, ports are provided on different sides of the adapter 10 decreasing the size of the adapter. The number of the ports depends on the controller 52 of the adapter 10.

After AC power is supplied to the source power connector 20 of the adapter 10, DC output power is transmitted to the computer main body 60, the IEEE 1394 controller 52 of the hub 50, and the IEEE 1394 6-pin port. The hub 50 of the adapter 10 controls the data communication between the external devices connected to the port 51 and amplifies the signal.

Other external devices connectable to the computer main body 60, or other client computer forming a local network, are connected to the port 51. Such external devices, or the client computer connected to the hub 50 through the port 51, have an IEEE 1394 controller such as the controller 61.

The computer main body 60 is operated as the host computer for the external device connected to the adapter 10. Alternatively, the connector 63 of the adapter is not connected to the computer main body 60, or a connection of the data line is turned off by switching of the switch 54. This separates the hub 50 in the adapter 10 and the computer main body 60 and the hub 50 is independently operable.

If an external device is connected to the adapter 10 using the IEEE 1394 controller and the 6-pin port, power is supplied not from the computer main body 60 but is supplied from the output power of the power converter 30 in the adapter 10 to the external device. Thus, the battery discharge from the computer main body is decreased.

A portable computer, especially a slim portable computer having a docking station with plural ports is synchronously connectable to external devices (DVD, CD-ROM, and the like) when the portable computer has the adapter 10.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A computer system, comprising:
an adapter;
a computer main body; and
a computer connector connecting the adapter and the computer main body, wherein the adapter comprises:
a source power connector connectable to an input power,
a power converter converting the input power into an output power,
an output power connector outputting the output power to the computer main body,
a plurality of ports connectable to at least one external device, and
a controller receiving the output power from the power converter and controlling a signal inputted/outputted to the at least one of the plurality of ports.

2. The computer system according to claim 1, wherein the computer connector comprises:
a power line supplying the output power to the computer main body from the output power connector, and
a data line communicating between the controller and the computer main body.

3. The computer system according to claim 1, wherein the adapter further comprises a voltage dropper decreasing a voltage of the output power and supplying the decreased voltage to the controller.

4. The computer system according to claim 1, further comprising a switch switching the supply of the output power to the controller.

5. The computer system according to claim 4, wherein the switch is a hardware switch or a software switch.

6. The computer system according to claim 4, wherein the switch switches a data line between the controller and the computer main body.

7. The computer system according to claim 1, wherein the controller and the at least one of the plurality of ports support a standard IEEE 1394 serial communication.

8. An adapter connectable to an external device, comprising:
a first connector connectible to a power source;
a second connector connectible to a computer; and
at least one port connectable to the external device and supplying at least one of data and power to the external device independently of the computer connection.

9. The adapter according to claim 8, further comprising:
a power converter converting an input power from the first connector; and
a hub connected to the power converter and connectable to the computer.

10. The adapter according to claim 9, wherein the power converter comprises:
at least one rectifier rectifying the input power, and
at least one source power current controller connected to the at least one rectifier.

11. The adapter according to claim 9, wherein the hub comprises:
a voltage dropper decreasing a voltage to be output to the external device,
a controller connected to the voltage dropper, and
a switch switching power output from the power converter to the controller, wherein the at least one port is included in the hub.

12. The adapter according to claim 9, wherein the first connector supplies the input power and the power converter converts the input power into an output power.

13. The adapter according to claim 10, wherein the controller receives an output power from the power converter and controls a signal inputted/outputted to the at least one connected port.

14. The adapter according to claim 11, wherein the controller and the at least port support a standard IEEE 1394 serial communication.

15. A computer system, comprising:
a computer; and
an adapter connectable to an external device and the computer,
wherein the adapter supplies power to the connected external device without a battery discharge from the computer.

16. The computer system according to claim 15, wherein the computer communicates data with the connected external device.

17. The computer system according to claim 16, the computer comprising:
a computer controller controlling the data communication, and
a computer connector communicating the data with the adapter.

18. The computer system according to claim 15, wherein the adapter comprises:
a first connector connectible to a power source;
a second connector connectible to the computer; and
at least one port connectable to the external device and supplying data and power to the external device independently of the computer connection.

19. The computer system according to claim 18, wherein the adapter further comprises:
a power converter converting power input from the first connector, and
a hub connected to the power converter and connectable to the computer.

20. The computer system according to claim 19, wherein the power converter comprises:
at least one rectifier rectifying the input power, and
at least one source power current controller connected to the at least one rectifier.

21. The computer system according to claim 19, wherein the hub comprises:
a voltage dropper decreasing a voltage to be output to the external device,
a controller connected to the voltage dropper, and
a switch switching power output from the power converter to the controller, wherein the at least one port is included in the hub.

22. The computer system according to claim 19, wherein the first connector supplies the input power and the power converter converts the input power into an output power.

23. The computer system according to claim 20, wherein the controller receives an output power from the power converter and controls a signal inputted/outputted to the at least one connected port.

24. The computer system according to claim 20, wherein the switch switches the data lines between the controller and the computer.

25. An adapter connectable to a computer and at least one external device, comprising:
a hub connectable to a power source; and
at least one port providing at least one of power and data to the external device without a discharge of a battery in the computer.

26. The adapter according to claim 25, wherein the adapter further comprises:
a power converter converting an input power from the power source into an output power.

27. The adapter according to claim 25, the hub comprising:
a controller controlling the power outputted to, and data signal inputted from and outputted to, the at least one port.

28. The adapter according to claim 27, wherein the controller and the at least one port support standard IEEE 1394 serial communication.

29. The adapter according to claim 25, the hub further comprising a switch switching the power supplied to the controller.

30. The adapter according to claim 25, the hub further comprising a voltage dropper decreasing a voltage from the power source.

31. The adapter according to claim 25, wherein power output from the power source is substantially rippleless DC power.

32. The adapter according to claim 26, the power converter comprising:
a primary rectifier and a secondary rectifier, and
a primary source power current controller checking and controlling a voltage and current of DC power rectified by the primary rectifier and loaded to, and consumed by, the secondary rectifier.

33. The adapter according to claim 32, the power converter further comprising a secondary source power current controller checking system loading and consumption of output DC power and feeding back the checked result of the output to the primary source power current controller.

34. The adapter according to claim 29, wherein the user chooses to cut off power supply to the hub.

35. A computer system, comprising:
a computer;
an adapter connectable to the computer; and
a plurality of external devices connectable to the adapter receiving power only from the adapter, and data from the computer.

36. The computer system according to claim 35, wherein AC power is supplied to the adapter and DC output power is transmitted from the adapter to the computer.

37. The computer system according to claim 35, further comprising a docking station with plural ports, wherein the portable computer is synchronously connectable to the external devices.

38. A method of conserving computer battery power in a computer system including at least one external device, comprising:
inputting power from a power source to an adapter connectable to the computer and the external device;
converting the input power into an output power;
controlling the output of the output power to the computer and the external device;
supplying data from the computer to the external device; and
supplying power from the adapter to the external device.

39. The method according to claim 38, wherein the supplying data and the supplying power support IEEE 1394 serial communication.

40. The method according to claim 38, wherein the converting the inputted power comprises:
rectifying input AC power to substantially rippleless output DC power;
checking and regulating voltage and current of rectified DC power; and
checking and feeding back system loading and consumption of output DC power.

41. The method according to claim 38, wherein controlling the output of the output power comprises decreasing a voltage of the DC output power.

42. The method according to claim 38, wherein the control of power is user controlled.

43. The method according to claim 38, further comprising switching data lines between the adapter and the computer.
